(19) United States
(12) Patent Application Publication
(10) Pub. No.: US 2010/0279636 A1
(43) Pub. Date: Nov. 4, 2010

(54) Frequency- and Phase-Modulation Telecontrol Receiver for Geostationary Satellite

(75) Inventors: Thierry Populus, Fontenilles (FR); Rodolphe Nasta, Toulouse (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/747,516

(22) PCT Filed: Dec. 8, 2008
(86) PCT No.: PCT/EP2008/067038

§ 371 Date: Jul. 19, 2010

(30) Foreign Application Priority Data
Dec. 11, 2007 (FR) FR0708624

(51) Int. Cl. H04B 1/06

(52) U.S. Cl. 455/144

(57) ABSTRACT

The subject of the present invention is a frequency and phase modulation remote control receiver for a geostationary satellite which is lighter and less expensive than the customary receivers, while not degrading the passband of the telecommunication equipment for its payload, and it is characterized in that it comprises a heterodyne amplifier analog input and filtering circuit (28) followed by a digital processing circuit (49) configurable as an FM demodulation device or as a PM demodulation device, the analog input circuit being common to both modes of demodulation.

The present invention pertains to a frequency and phase modulation (PM/FM) remote control receiver for a geostationary satellite.

Placing a geostationary satellite on station (or placing it at its service altitude) requires an ability of the remote control receiver to capture the upgoing signal over a wide frequency swing (because of the spurious Doppler effects). This ability becomes a drawback when maintaining on station, particularly in the case of co-located satellites which require as narrow a band as possible, so as to juxtapose the multiple remote control reception bands without penalizing the band allocated for the satellite payload requirements.

The solution generally used of a single sub-system for placing on station and maintaining on station, penalizes the band allocated to the payload's telecommunications mission. This can become prohibitive in the case of co-location.

The known solution for coping with this drawback is duplication into two distinct remote control sub-systems, one for placing on station, the other for maintaining on station. This solution is penalizing in terms of weight and cost.

The subject of the present invention is a frequency and phase modulation remote control receiver for a geostationary satellite which is the lightest and the least expensive possible, while not degrading the passband of the telecommunication equipment for its payload.

The receiver in accordance with the invention is characterized in that it comprises a heterodyne amplifier analog input and filtering circuit followed by a digital processing circuit comprising a device configurable as an FM demodulation device or as a PM demodulation device, the analog input circuits being common to both modes of demodulation.

Thus, the invention consists in grouping together in one and the same remote control receiver the functionalities making it possible to ensure placement on station and maintenance on station with optimal performance.

The present invention will be better understood on reading the detailed description of an embodiment, taken by way of non-limiting example and illustrated by the appended drawing in which:

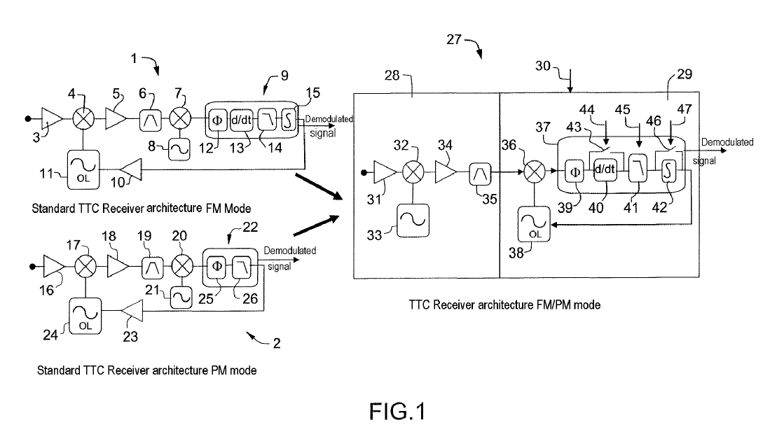

FIG. 1 is a block diagram of a remote control receiver in accordance with the invention showing, in its left part, PM and FM receivers of the prior art and, in its right part, a receiver in accordance with the invention, and

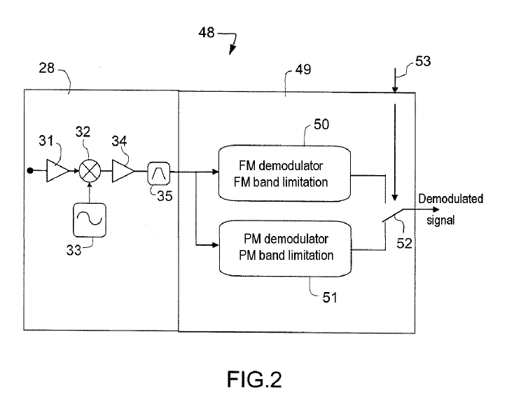

FIG. 2 is a block diagram of a variant of the remote control receiver of the invention.

At the top of the left part of FIG. 1 of the drawing has been represented a remote control receiver 1 in FM mode with standard architecture for a satellite, and at the bottom of this left part has been represented a remote control receiver 2 in PM mode with standard architecture for the same satellite.

The receiver 1 essentially comprises: an input amplification circuit 3 linked to a first input of a phase comparator 4 included in a frequency latching loop comprising, in order, an amplifier 5 linked to the output of the comparator 4, an FM band limitation bandpass filter 6, a mixer 7 linked moreover to a local oscillator 8, an FM circuit 9 and an amplifier 10 whose output is linked to the voltage control input of an oscillator 11 whose output is linked to a second input of the comparator 4. The circuit 9 comprises a phase detector 12, a differentiator 13, a low-pass filter 14 and an integrator 15.

The receiver 2 essentially comprises: an input amplification circuit 16 linked to a first input of a phase comparator 17 included in a phase latching loop comprising, in order, an amplifier 18 linked to the output of the comparator 17, a PM band limitation bandpass filter 19, a mixer 20 linked moreover to a local oscillator 21, a PM circuit 22, and an amplifier 23 whose output is linked to the voltage control input of an oscillator 24 whose output is linked to a second input of the comparator 14. The circuit 22 comprises a phase detector 25 and a low-pass filter 26.

In the right part of the drawing has been shown diagrammatically a remote control receiver 27 in accordance with the invention. This receiver essentially comprises a block 28 of analog input circuits constituting a heterodyne amplifier and filtering circuit and a block 29 of circuits that can be configured either in PM mode or in FM mode under the control of a configuration control signal 30, itself originating from an appropriate remote control signal dispatched from the satellite command station.

The block of analog input circuits 28 comprises, in order, from its input, an amplification circuit 31, a mixer 32 linked to a local oscillator 33, an amplifier 34 and a bandpass filter 35.

The block of digital circuits 29 essentially comprises a loop configurable as a phase loop or as a frequency loop under the control of the signal 30. This configurable loop comprises a phase comparator 36 followed by a band demodulating and limiting circuit 37 and by a local oscillator 38 controlled by the output signal of the circuit 37 and whose output is linked to the comparator 36. The circuit 37 comprises, in the present example, in cascade, a phase detector 39, a differentiator 40, a controlled low-pass filter 41 and an integrator 42. A switch 43 controlled by a signal 44 is wired up in parallel with the differentiator 40. The filter 41 is controlled by a signal 45 so as to make the cutoff frequency thereof toggle between two values corresponding either to the FM band limitation, or to the PM band limitation. A switch 46, controlled by a signal 47 is wired up in parallel with the integrator 42. The three signals 44, 45 and 47 are contained in the remote control signal 30, itself multiplexed in the general remote control signal received by the satellite whose other components are the customary remote control signals. The block 29 is advantageously embodied in the form of a digital processing integrated circuit.

Thus, when the switches 43 and 46 are open and the cutoff frequency of the filter 45 is forced to a value corresponding to the FM limitation, the receiver of the invention 27 (composed of the blocks 28 and 29) behaves like the conventional receiver 1, operating in FM mode, that is to say in FM demodulation responding to the modulation standard used for placing on station and ensuring wide frequency capture.

When the switches 43 and 46 are closed and the cutoff frequency of the filter 45 is forced to a value corresponding to the PM limitation, the receiver 27 behaves like the conventional receiver 2 in PM mode, that is to say in PM demodulation meeting a requirement for maintaining on station and ensuring strong rejection of the adjacent signals.

The variant embodiment of the receiver of the invention shown diagrammatically in FIG. 2 comprises an analog circuit 28 identical to that of FIG. 1, followed by a digital processing circuit 49 whose input is linked to the output of the filter 35. This circuit 49 comprises a demodulator and band limiter circuit 50 for the FM mode, a demodulator and band limiter circuit 51 for the PM mode, and a controlled switch 52 making it possible to select either the circuit 50 or the circuit 51. In the example represented in the drawing, the switch 52 is downstream of the circuits 50 and 51, but it can also be disposed upstream of these circuits, and in the latter case, an “OR” circuit then linking the outputs of these two circuits to the output of the circuit 49. This switch is controlled by a remote control signal 53 multiplexed, like the signal 30, in the general remote control signal received by the satellite. This switch activates one of the two demodulator and band limiter devices (50 or 51). The demodulation and band limitation functions of the circuits 50 and 51 are the same as those obtained in the block 29 when the switches are respectively open and closed.

In the modular architecture of the receiver of the invention, the analog chain is common to both modes PM and FM, this not being the case for the customary architectures of remote control receivers, in which selective filtering is ensured by a PM or FM dedicated analog filter. Moreover the feedback loops of the local oscillator (OL) have characteristics which differ from one mode to another. The grouping of the two modes into one and the same item of equipment of the prior art is therefore not conceivable. In the architecture of the invention, selective filtering is ensured by the digital demodulator.

Relative to conventional dual PM/FM receivers (such as those represented in the left part of the drawing), the receiver of the invention exhibits the advantage of roughly a halving of the cost and weight of the remote control sub-system.

A toggling to FM during the phase of placing on station and a toggling to PM while maintaining on station were described above for the preferred mode of implementation of the invention. However, while maintaining on station, it is possible to toggle to FM mode in particular cases, for example in stand-by mode.

1. A frequency and phase modulation remote control receiver for a geostationary satellite, comprising a heterodyne amplifier analog input and filtering circuit followed by a digital processing circuit configurable as an FM demodulation device or as a PM demodulation device, the analog input circuit being common to both modes of demodulation.

2. The remote control receiver as claimed in claim 1, wherein the digital processing circuit comprises a latching loop comprising functions switchable according to a PM or FM demodulation loop configuration as well as a filter controlled by a remote control signal so as to make the cutoff frequency thereof toggle between two values corresponding either to the FM band limitation, or to the PM band limitation.

3. The remote control receiver as claimed in claim 2, wherein the switchable functions are a differentiator and an integrator.

4. The remote control receiver as claimed in claim 2, wherein the digital processing circuit comprises an FM demodulator and band limiter device, a PM demodulator and band limiter device and a switch controlled by said remote control signal and activating one of these two demodulator and band limiter devices.

5. The remote control receiver as claimed in claim 1, wherein the analog input circuit comprises a heterodyning circuit and a bandpass filter.
